(19) United States
(12) Patent Application Publication
(10) Pub. No.: US 2019/0390485 A1
(43) Pub. Date: Dec. 26, 2019

(54) METHOD OF CONTROLLING A VEHICLE DOOR LOCK SYSTEM

(71) Applicant: GM GLOBAL TECHNOLOGY OPERATIONS LLC, Detroit, MI (US)

(72) Inventors: Jeffrey L. Konchan, Romeo, MI (US); Besi Rrumbullaku, Rochester, MI (US)

(21) Appl. No.: 16/016,803

(22) Filed: Jun. 25, 2018

(51) Int. Cl. E05B 77/24; E05B 81/00; E05B 83/36

(52) U.S. Cl. CPC E05B 77/24; E05B 81/00; E05B 83/36; E05Y 2900/531; E05Y 2400/45; E05Y 2400/86; E05Y 2400/44

(57) ABSTRACT

A method of controlling a vehicle includes sensing movement of an interior door handle, sensing a position of a vehicle door after movement of the interior door handle is sensed to determine if the door remains in an unopened position or if the door moves into an opened position after movement of the interior door handle is sensed. When movement of the interior door handle is sensed, a timer is started to determine if the measured time period is equal to or greater than a maximum delay time. A active or inactive state of a double door lock feature of the door lock system is determined and a control signal to automatically generated to deactivate the double door lock feature if the double door lock feature is active, the measured time period is equal to or greater than the maximum delay time, and the door is in the unopened position.

### INTRODUCTION

The present invention relates generally to the field of vehicles and, more specifically, to a method of controlling a door lock system of a vehicle.

Doors of vehicles include a door latch to secure the door to the body of the vehicle, and a door lock system to lock the door latch, and prevent the door from being opened from an exterior of the vehicle. When the door lock system is disposed in a locked state, the door may be opened from the interior of the vehicle by operating an interior door handle. In some vehicles, the door lock system may be equipped with a double door lock feature. When activated, the double door lock feature prevents the door lock system from being unlocked and opened with either an exterior door handle or the interior door handle. Typically, the double door lock feature may only be inactivated or released by a remote, electronic keyless entry device, by an electronic signal from a vehicle lock controller, or by insertion and manipulation of a key in a key cylinder in the driver's side door.

### SUMMARY

Embodiments according to the present disclosure provide a number of advantages. For example, embodiments according to the present disclosure enable automatic control of a double door lock feature based on the satisfaction of various operating conditions or criteria.

In one aspect, a method of controlling a vehicle is provided. The method includes sensing movement of an interior door handle of the vehicle with a sensing device, sensing a position of a door of the vehicle with a door position sensor after movement of the interior door handle is sensed. The position of the door is sensed to determine if the door remains in an unopened position after movement of the interior door handle is sensed, or if the door moves into an opened position after movement of the interior door handle is sensed. When movement of the interior door handle is sensed, an opening attempt timer is started to measure a time period, and the measured time period is compared to a maximum delay time, when the door remains in the unopened position after movement of the interior door handle is sensed, to determine if the measured time period is equal to or greater than the maximum delay time, or if the measured time period is less than the maximum delay time. The method also includes sensing a current status of a door lock system with a lock switch to determine if the door lock system is disposed in a locked state or if the door lock system is disposed in an unlocked state, wherein sensing the current status of the door lock system includes sensing a current state of a double door lock feature of the door lock system to determine if the double door lock feature is disposed in an active state or if the door lock system is disposed in an inactive state, and automatically generating a control signal to deactivate the double door lock feature if the double door lock feature is disposed in the active state, the measured time period is equal to or greater than the maximum delay time, and the door is in the unopened position.

In some aspects, the method further includes providing instructions with an audio or video device related to a proper procedure for unlocking and opening the door, when movement of the interior door handle is sensed and the door remains in the unopened position after movement of the interior door handle.

In some aspects, providing instructions with the audio or video device is further defined as providing instructions with the audio or video device when the measured time period is equal to or greater than the maximum delay time.

In some aspects, the method further includes resetting a value of an instruction counter equal to zero when the instructions are provided and incrementing a value of the instruction counter by one for each time instructions are provided.

In some aspects, the method further includes comparing the value of the instruction counter to a first counter value, with a vehicle lock controller, to determine if the value of the instruction counter is equal to or greater than the first counter value, or if the value of the instruction counter is less than the first counter value.

In some aspects, the method further includes automatically contacting a service provider, with an onboard communication device of the vehicle, to request assistance in opening or unlocking the door of the vehicle, when the value of the instruction counter is equal to or greater than the first counter value.

In some aspects, the method further includes starting a double door lock timer to measure a second time period after contacting the service provider.

In some aspects, the method further includes comparing the measured second time period to a maximum lock delay time, with the vehicle lock controller, when the double door lock feature remains in the inactive state, to determine if the measured second time period is equal to or greater than the maximum lock delay time or if the measure second time period is less than the maximum lock delay time.

In some aspects, the method further includes generating a control signal to activate the double door lock feature if the double door lock feature is disposed in the inactive state, the measured second time period is equal to or greater than the maximum lock delay time, and the door is in the closed position.

In another aspect, a method of controlling a door lock system of a vehicle is provided. The method includes sensing a current status of the door lock system with a lock switch to determine if the door lock system is disposed in a locked state or if the door lock system is disposed in an unlocked state, wherein sensing the current status of the door lock system includes sensing a current state of a double door lock feature of the door lock system to determine if the double door lock feature is disposed in an active state or if the door lock system is disposed in an inactive state, sensing movement of an interior door handle of the door with a sensing device, starting an opening timer to measure a time period after movement of the interior door handle is sensed, sensing a position of the door of the vehicle with a door position sensor after movement of the interior door handle is sensed, to determine if the door remains in an unopened position after movement of the interior door handle is sensed, or if the door moves into an opened position after movement of the interior door handle is sensed, comparing the measured time period to a maximum delay time, with a vehicle lock controller, when the door remains in the unopened position after movement of the interior door handle is sensed, to determine if the measured time period is equal to or greater than the maximum delay time, or if the measured time period is less than the maximum delay time, automatically generating a control signal to deactivate the double door lock feature if the double door lock feature is disposed in the active state, the measured time period is equal to or greater than the maximum delay time, and the door is in the unopened position, and automatically contacting a service provider, with an onboard communication device of the vehicle, to request assistance in opening or unlocking the door of the vehicle, when the double door lock feature is in the inactive state, the measured time period is equal to or greater than the maximum delay time, and the door is in the unopened position.

In some aspects, the method further includes providing instructions with an audio or video device related to a proper procedure for unlocking and opening the door, when movement of the interior door handle is sensed, the door remains in the unopened position after movement of the interior door handle, and the measured time period is equal to or greater than the maximum delay time.

In some aspects, the method further includes incrementing a value of an instruction counter by one for each time instructions are provided.

In some aspects, the method further includes automatically contacting the service provider, with an onboard communication device of the vehicle, to request assistance in opening or unlocking the door of the vehicle, when the value of the instruction counter is equal to or greater than a first counter value.

In some aspects, the method further includes moving the door lock system from the locked state to the unlocked state, with the vehicle lock controller, in response to a signal remotely sent from the service provider.

In yet another aspect, a method of controlling a vehicle is provided. The method includes sensing movement of an interior door handle of the vehicle with a sensing device, sensing a position of a door of the vehicle with a door position sensor after movement of the interior door handle is sensed, to determine if the door remains in an unopened position after movement of the interior door handle is sensed, or if the door moves into an opened position after movement of the interior door handle is sensed, sensing a current status of a door lock system with a lock switch to determine if the door lock system is disposed in a locked state or if the door lock system is disposed in an unlocked state, wherein sensing the current status of the door lock system includes sensing a current state of a double door lock feature of the door lock system to determine if the double door lock feature is disposed in an active state or if the door lock system is disposed in an inactive state, and automatically generating a control signal to deactivate the double door lock feature if the double door lock feature is disposed in the active state and the door is in the unopened position.

In some aspects, the method further includes starting an opening attempt timer to measure a time period when movement of the interior door handle is sensed, and comparing the measured time period to a maximum delay time, with a vehicle lock controller, when the door remains in the unopened position after movement of the interior door handle is sensed, to determine if the measured time period is equal to or greater than the maximum delay time, or if the measured time period is less than the maximum delay time, and automatically generating a control signal to deactivate the double door lock feature if the double door lock feature is disposed in the active state, the measured time period is equal to or greater than the maximum delay time, and the door is in the unopened position.

In some aspects, the method further includes providing instructions with an audio or video device related to a proper procedure for unlocking and opening the door, when movement of the interior door handle is sensed and the door remains in the unopened position after movement of the interior door handle, wherein providing instructions with the audio or video device is further defined as providing instructions with the audio or video device when the measured time period is equal to or greater than the maximum delay time.

In some aspects, the method further includes resetting a value of an instruction counter equal to zero when the instructions are provided and incrementing a value of the instruction counter by one for each time instructions are provided.

In some aspects, the method further includes comparing the value of the instruction counter to a first counter value, with a vehicle lock controller, to determine if the value of the instruction counter is equal to or greater than the first counter value, or if the value of the instruction counter is less than the first counter value.

In some aspects, the method further includes automatically contacting a service provider, with an onboard communication device of the vehicle, to request assistance in opening or unlocking the door of the vehicle, when the value of the instruction counter is equal to or greater than the first counter value.

### BRIEF DESCRIPTION OF THE DRAWINGS

The present disclosure will be described in conjunction with the following figures, wherein like numerals denote like elements.

FIG. 1 is a schematic plan view of a vehicle, according to an embodiment.

FIG. 2 is a flowchart representing a method of controlling the vehicle.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings Δny dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

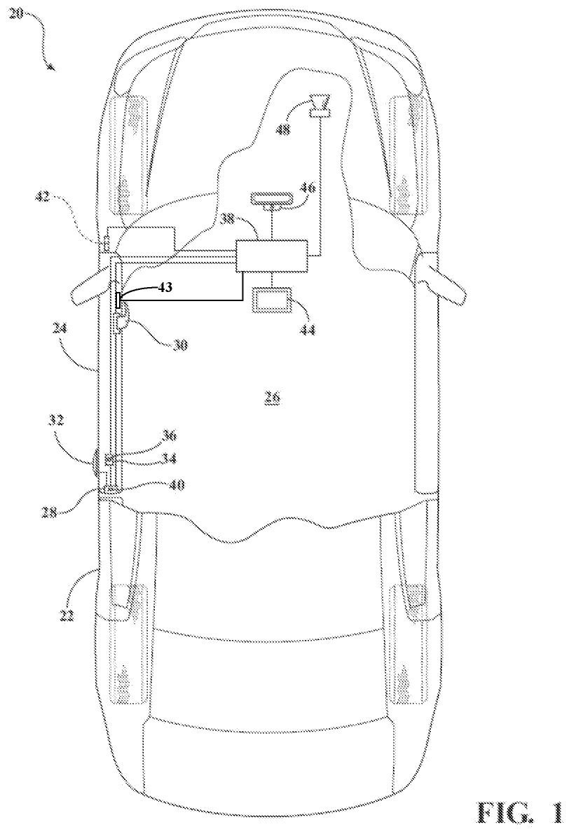

Referring to the Figures, wherein like numerals indicate like parts throughout the several views, a vehicle is generally shown at 20 in FIG. 1. Referring to FIG. 1, the vehicle 20 includes a body 22, and at least one door 24 that provides ingress/egress into an interior passenger compartment 26 of the vehicle 20. The door 24 includes a latch 28 that is operable to secure the door 24 relative to the body 22, to prevent the door 24 from moving out of a closed position as is known in the art. When the latch 28 is engaged and the door 24 is secured by the latch 28, the door 24 is secured relative to the body 22 in a closed position. When the latch 28 is disengaged, i.e., when the door 24 is unlatched, the door 24 is free to move between the closed position and an open position. The latch 28 may include any suitable style and/or configuration of latch 28 known to those skilled in the art. For example, the latch 28 may include a fork bolt (not shown) supported by the door 24, that is rotatable to engage a striker (not shown) that is supported by the body 22. The latch 28 may be actuated by either an interior door handle 30, or an exterior door handle 32, as is known in the art.

The door 24 further includes a door lock system 34. The door lock system 34 is operable to lock the latch 28 of the door 24, to prevent the latch 28 from being moved from the engaged position into the disengaged position. The door lock system 34 may include any suitable style and/or configuration of lock capable of locking the latch 28 of the door 24. The door lock system 34 is moveable between a locked state, and an unlocked state. When disposed in the locked state, the door lock system 34 locks the latch 28, and prevents the latch 28 from being disengaged. When disposed in the unlocked state, the door lock system 34 does not interfere with the latch 28, and allows the latch 28 to be manipulated between the engaged state and the disengaged state.

The door lock system 34 may further include a double door lock feature 36. The double door lock feature 36 operates as is known in the art to lock the door lock system 34, and prevent actuation of the latch 28 by either the interior door handle 30 or the exterior door handle 32. The double door lock feature 36 may include any device capable of mechanically locking the door lock system 34 in the locked state, and preventing either the interior door handle 30 or the exterior door handle 32 from actuating the latch 28. When the double door lock feature 36 is active, the double door lock feature 36 prevents the door lock system 34 from moving from the locked state into the unlocked state, thereby preventing either the interior door handle 30 or the exterior door handle 32 from actuating the latch 28. Typically, the double door lock system 34 is controlled via a control signal from a vehicle lock controller 38. The vehicle lock controller 38 may send the control signal when signaled by a remote keyless entry device. Alternatively, the vehicle lock controller 38 may send the control signal to inactivate the double door lock feature 36 in response to a signal from a remote service provider. Alternatively, as discussed herein, the vehicle lock controller 38 or any vehicle 20 controller may send the control signal to inactivate the double door lock feature 36 in response to satisfaction of one or more sensed and/or determined vehicle conditions, such as, for example and without limitation, movement of the interior door handle 30, a position of the door 24, and an elapsed time since a first sensed movement of the interior door handle 30.

The vehicle 20 may further include a lock switch 40 coupled to the door lock system 34. The lock switch 40 is operable to sense the state of the door lock system 34, i.e., the locked state or the unlocked state, and move the door lock system 34 between the locked state and the unlocked state. The lock switch 40 may include any type and/or style of switch suitable for use with the door lock system 34, and capable of moving the door lock system 34 between the locked state and the unlocked state. The lock switch 40 is in electronic communication with the vehicle lock controller 38. The vehicle lock controller 38 is operable to send and receive control signals with and between the lock switch 40 to determine the state of the door lock system 34, and control the state of the door lock system 34.

The vehicle 20 may further include a door position sensor 42 that is operable to sense a position of the door, i.e., the unopened or closed position or the opened position. The door position sensor 42 may include any suitable type of sensor that is capable of sensing the position of the door 24, i.e., sensing whether the door 24 is in the closed position, or is in the open position. The door position sensor 42 may also be operable to sense continuous movement of the door 24 relative to the body 22. The door position sensor 42 is in electronic communication with the vehicle lock controller 38. The vehicle lock controller 38 is operable to send and receive signals with and between the door position sensor 42 to determine and/or identify the current position of the door 24.

The vehicle 20 may further include a door handle position sensor 43 that is operable to sense a position of the interior door handle 30, i.e., the unopened or closed position or the opened position. The door handle position sensor 43 may include any suitable type of sensor that is capable of sensing the position of the interior door handle 30, i.e., sensing whether the interior door handle 30 is in the closed position, or is in the open position. The door handle position sensor 43 is in electronic communication with the vehicle lock controller 38. The vehicle lock controller 38 is operable to send and receive signals with and between the door handle position sensor 43 to determine and/or identify the current position of the interior door handle 30.

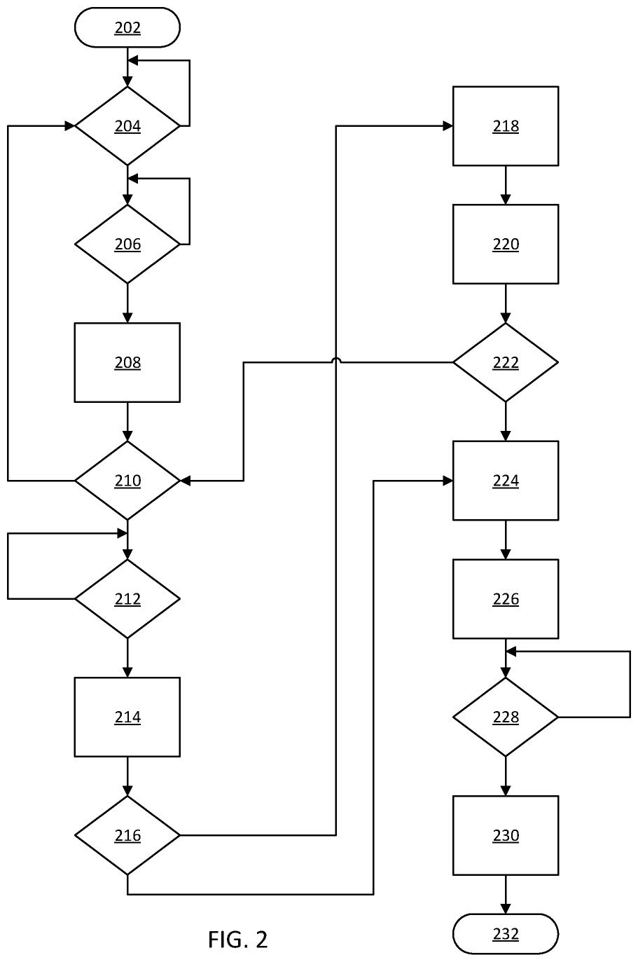

The vehicle lock controller 38 is operable to control the door lock system 34, including the double door lock feature 36. The vehicle lock controller 38 may include a computer and/or processor, and include all software, hardware, memory, algorithms, connections, sensors, etc., necessary to manage and control the operation of the door lock system 34 and the double door lock feature 36. As such, a method, described below and generally shown in FIG. 2, may be embodied as a program operable on the vehicle lock controller 38. It should be appreciated that the vehicle lock controller 38 may include any device capable of analyzing data from various sensors and/or switches, comparing data, making the necessary decisions required to control the operation of the door lock system 34 and the double door lock feature 36, and executing the required tasks necessary to control the operation of the door lock system 34 and the double door lock feature 36.

The vehicle lock controller 38 includes a tangible non-transitory memory having computer executable instructions recorded thereon, including a lock control module. The vehicle lock controller 38 further includes a processor that is operable to execute the lock control module to perform the steps of the method described below. The lock control module uses the data from the vehicle 20 sensor(s) and/or switches to determine the position and/or state of the door 24, the door lock system 34, and if so equipped, the state of the double door lock feature 36.

The vehicle lock controller 38 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory may include any non-transitory/tangible medium which participates in providing data or computer-readable instructions. Memory may be non-volatile or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a CD-ROM, DVD, and/or any other optical medium, as well as other possible memory devices such as flash memory.

The vehicle 20 may further include an audio and/or video device 44 coupled to the vehicle lock controller 38. The audio and/or video device 44 is operable to communicate a message to an occupant of the vehicle 20, through either audio or video outputs. For example, the audio and/or video device 44 may include, but is not limited to, speakers, a video screen, or a combination of both. The audio and/or video device 44 is in electronic communication with the vehicle lock controller 38, which provides the output signal for the audio and/or video device 44.

The vehicle lock controller 38 may further be coupled to an onboard communication device 46. The onboard communication device 46 is operable to contact a remote service provider, when activated. For example, the onboard communication device 46 may include a cellular or digital device capable of calling and/or sending an electronic communication to a designated service provider. The onboard communication device 46 may be activated by the vehicle lock controller 38 to contact the service provider located remote from the vehicle 20, to request assistance.

The vehicle 20 may further be equipped with an alarm system 48. The alarm system 48 is operable to emit an alert to signal a potential break-in of the vehicle 20. The alarm system 48 may include any style and/or type of alarm suitable for use in the vehicle 20, and as known in the art. Typically, when activated, the alarm system 48 provides an auditory and visual alarm to draw attention to the vehicle 20. Additionally, the alarm system 48 may be remotely connected to a service provider to alert the remote service provider.

Referring to FIG. 2, a method of controlling the vehicle 20, and more specifically a method of controlling the door lock system 34 of the vehicle 20, is generally described. The method begins at 202 and proceeds to 204. At 204, the method includes sensing any movement or actuation of the interior door handle 30. Movement of the interior door handle 30 is sensed to determine if a vehicle occupant is attempting to open the door 24 from the inside of the vehicle, that is, whether a position of the interior door handle 30 has changed from an unopened position to an opened position. The vehicle lock controller 38 may sense and/or determine movement of the interior door handle 30 in any suitable manner. For example, the vehicle 20 controller may sense and/or determine movement of the interior door handle 30 based on data received from a sensing device, such as the door handle position sensor 43 or the lock switch 40. However, it should be appreciated that the vehicle lock controller 38 may use some other sensor capable of sensing the position and/or status of the interior door handle 30 to determine movement of the interior door handle 30.

If the vehicle lock controller 38 does not sense or otherwise determine any movement of the interior door handle 30, generally indicated at 204, then no action is taken other than to continue monitoring and sensing for any movement of the interior door handle 30. When the vehicle lock controller 30 determines that the interior door handle 30 has moved, that is, movement is generally sensed, the method 200 proceeds to 206.

At 206, the vehicle lock controller 38 senses and/or determines a current status of the double door lock feature 36. Determining the current status of double door lock feature 36 includes determining whether the double door lock feature 36 is in an active or inactive state. The vehicle lock controller 38 may sense the status of the double door lock feature 36 in any suitable manner. For example, the vehicle 20 controller may sense and/or determine the status of the double door lock feature 36 based on data received from the lock switch 40. However, it should be appreciated that the vehicle lock controller 38 may use some other sensor capable sensing the position and/or status of the double door lock feature 36 to determine the current status of the double door lock feature 36.

If the vehicle lock controller 38 determines that the double door lock feature 36 is active, the method 200 proceeds to 208. At 208, the vehicle lock controller 38 resets an opening attempt timer to a time of zero, and then starts the opening attempt timer to measure an elapsed time period since movement of the interior door handle 30 was sensed. The opening attempt timer is preferably integrated into the vehicle lock controller 38 and is operable to measure time. The opening attempt timer may include any device capable of measuring time, such as an electronic clock, and store in the memory of the vehicle lock controller 38 the elapsed period of time since the movement of the interior door handle 30 was sensed. It should be appreciated that the opening attempt timer measures the period of time continuously until stopped and reset to a value of zero.

Next, at 210, the vehicle lock controller 38 senses and/or determines a position of the door 24. The vehicle lock controller 38 senses the position of the door 24 to determine if the door 24 remains in an unopened position after movement of the interior door handle 30 is sensed, or if the door 24 moves into an opened position after movement of the interior door handle 30 is sensed. The vehicle lock controller 38 may sense the position of the door 24 in any suitable manner. For example, the vehicle 20 controller may sense and/or determine the position of the door 24 based on data received from the door position sensor 42. However, it should be appreciated that the vehicle lock controller 38 may use some other sensor capable sensing the position and/or status of the door 24 to determine the current position and/or change in position of the door 24.

If the vehicle lock controller 38 senses or determines that the position of the door 24 has moved from the unopened position into the opened position after movement of the interior door handle 30, then the vehicle lock controller 38 returns to continue to monitor or sense for actuation or movement of the interior door handle 30, at 204. If the vehicle lock controller 38 senses or determines that the position of the door 24 has not changed, and that the door 24 remains in the unopened position after movement of the interior door handle 30 is sensed, then the method 200 proceeds to 212. At 212, the vehicle lock controller 38 compares the measured time period, as measured by the opening attempt timer, to a maximum delay time. The measured time period is compared to the maximum delay time to determine if the measured time period is equal to or greater than the maximum delay time, or if the measured time period is less than the maximum delay time. The maximum delay time is a pre-defined period of time allotted to allow an occupant of the vehicle 20 to move the door 24 from the unopened position into the opened position. It may be assumed that if an occupant fails to move the door 24 from the unopened position into the opened position within the maximum delay time, and after actuating the interior door handle 30, that the occupant is for some reason unable to open the door 24.

If the vehicle lock controller 38 determines that the current measured time, measured by the opening attempt timer, is less than the maximum delay time, then the vehicle lock controller 38 continues to monitor or sense movement of the door 24 to determine if the door 24 remains in the unopened position, or is moved into the opened position. However, if the vehicle lock controller 38 determines that the current measured time, measured by the opening attempt timer, is equal to or greater than the maximum delay time, and the door 24 has not been moved into the opened position, then the method 200 proceeds to 214.

At 214, the vehicle lock controller 38 or any other vehicle 20 controller, such as a body control module (BCM) sends a signal to deactivate the double door lock feature 36. The vehicle lock controller 38 or any other vehicle 20 controller generates the control signal to automatically deactivate the double door lock feature 36 when it is determined, based on the current measured time and the status of the position of the door, that the occupant has not successfully opened the door 24.

Next, at 216, the vehicle lock controller 38 senses and/or determines a status of the door lock system 34, that is, whether the door lock system 34 is in a locked state or an unlocked state. Sensing and/or determining whether the door lock system 34 is in a locked state or an unlocked state additionally provides information on whether the signal to deactivate the double door lock feature 36 was successfully received and completed by the door lock system 34.

If the vehicle lock controller 38 senses and/or determines that the double door lock feature 36 is inactive, the method 200 proceeds to 218. At 218, if the vehicle lock controller 38 determines that the current measured time, measured by the opening attempt timer, is equal to or greater than a maximum instruction time, then the vehicle lock controller 38 provides instructions related to the proper procedure for unlocking and/or opening the door 24. The instructions may be provided to the occupant through or by any suitable device, such as an audio device, video device, or a combination of audio and/or video devices 44. For example, the vehicle lock controller 38 may provide audio instructions to the occupant on the proper procedure for unlocking and opening the door 24 from the interior of the vehicle 20 through the vehicles 20 radio system, or other system speakers. Alternatively, if the vehicle 20 is equipped with a video display/control center, then the vehicle lock controller 38 may display the proper instructions for the occupant. In some embodiments, the vehicle lock controller 38 may display and/or provide the instructions to the occupant multiple times. In some embodiments, the vehicle lock controller 38 requests an input from the occupant to acknowledge receipt of the instructions. The input may be received through any suitable device, such as the video display/control center.

Next, at 220, the vehicle lock controller 38 resets a value of an instruction counter. The value of the instruction counter is reset to equal zero when the vehicle lock controller 38 provides the first instruction related to the proper procedure for unlocking and/or opening the door 24. The instruction counter is preferably integrated into the vehicle lock controller 38 and is operable to count the number of times the instructions provided to the occupant. The instruction counter may include any device capable of tracking and storing in the memory of the vehicle lock controller 38 the number of times the instructions are provided to the occupant. The vehicle lock controller 38 increments the value of the instruction counter by one for each time the instructions are provided to the occupant. For example, the first time that the vehicle lock controller 38 provides instructions to the occupant, the value of the instruction counter is increased from a value of zero to a value of one. The second time the vehicle lock controller 38 provides instructions to the occupant, the value of the instruction counter is increased from a value of one to a value of two. This process continues each time the vehicle lock controller 38 provides instructions to the occupant until the value of the instruction counter is reset to zero.

The method 200 then proceeds to 222. At 222, the vehicle lock controller 38 compares the value of the instruction counter to a first counter value. The value of the instruction counter is compared to the first counter value to determine if the value of the instruction counter is equal to or greater than the first counter value, or if the value of the instruction counter is less than the first counter value. The first counter value is a pre-defined value allotting a number of times instructions were provided to the occupant. In some embodiments, the first counter value is two, thus allowing a maximum of two occurrences of providing instructions to the occupant. In some embodiments, the first counter value is 3, 4, 5 or more occurrences of providing instructions to the occupant.

If the vehicle lock controller 38 senses and/or determines that the double door lock feature 36 remains in the active state, generally indicated at 216, or if the vehicle lock controller 38 determines that the value of the instruction counter is greater than or equal to the first counter value, generally indicated at 222, the method 200 proceeds to 224. At 224, the vehicle lock controller 38 automatically contacts a service provider. The vehicle lock controller 38 may contact the remote service provider with the onboard communication device 46 of the vehicle 20, to request assistance in opening or unlocking the door 24 of the vehicle 20. For example, the vehicle lock controller 38 may contact a remote service provider and request that an emergency vehicle 20 be directed to the current location of the vehicle 20 to assist the occupant in exiting the vehicle 20. Alternatively, after initiating contact with the remote service provider such that the remote service provider may verify the identity of the occupant, the remote service provider may signal the vehicle lock controller 38 from a remote location to move the door lock system 34 from the locked state into the unlocked state and to signal the vehicle lock controller 38 to deactivate the double door lock feature 36 to allow the occupant to open the door 24.

If the vehicle lock controller 38 determines that the value of the instruction counter is less than the first counter value, generally indicated at 222, the vehicle lock controller 38 continues to sense and/or determine a position of the door 24, generally indicated at 210. In some embodiments, after the vehicle lock controller 38 contacts the remote service provider, generally indicated at 224, the vehicle lock controller 38 continues to sense and/or determine a position of the door 24, generally indicated at 210. The method 200 then proceeds as discussed herein.

In some embodiments, after the vehicle lock controller 38 contacts the remote service provider, generally indicated at 224, the vehicle lock controller 38 resets a double door lock timer to a time of zero and then starts the double door lock timer to measure an elapsed time period since contact was made with the remote service provider, generally indicated at 226. The double door lock timer is preferably integrated into the vehicle lock controller 38 and is operable to measure time. The double door lock timer may include any device capable of measuring time, such as an electronic clock, and store in the memory of the vehicle lock controller 38 the elapsed period of time since the remote service provider was contacted. It should be appreciated that the double door lock timer measures the period of time continuously until stopped and reset to a value of zero.

Next, at 228, the vehicle lock controller 38 compares the measured time period, as measured by the double door lock timer, to a predefined maximum lock delay time. The measured time period is compared to the maximum lock delay time to determine if the measured time period is equal to or greater than the maximum lock delay time, or if the measured time period is less than the maximum lock delay time. The maximum delay time is a pre-defined period of time allotted before re-activation of the double door lock feature 36. In some embodiments, the maximum lock delay time is approximately two minutes. In other embodiments, the maximum lock delay time is approximately one minute, approximately three minutes, approximately four minutes, or any other amount of time less than or equal to approximately five minutes and may be calibratable based on vehicle location considerations, among other factors, for example and without limitation.

If the vehicle lock controller 38 determines that the current measured time, measured by the double door lock timer, is less than the maximum lock delay time, then the vehicle lock controller 38 continues to monitor the status of the double dour lock feature 36 and the elapsed time. However, if the vehicle lock controller 38 determines that the current measured time, measured by the double door lock timer, is greater than or equal to the maximum lock delay time, the double door lock feature 36 is inactive, and the door 24 is in the unopened position, then the method 200 proceeds to 230. At 230, the vehicle door lock controller 38 or any other vehicle controller 20, such as the body control module (BCM), sends a signal to activate the double door lock feature 36. The method 200 then either ends, as generally indicated by box 232, or repeats continuously, returning to the start at 202 and proceeding as discussed herein.

The order of operation of the method 200 is not limited to the sequential execution as illustrated in FIG. 2, but may be performed in one or more varying orders, or steps may be performed simultaneously, as applicable in accordance with the present disclosure.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3.” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be onboard as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method of controlling a vehicle, the method comprising:
sensing movement of an interior door handle of the vehicle with a sensing device;
sensing a position of a door of the vehicle with a door position sensor after movement of the interior door handle is sensed, to determine if the door remains in an unopened position after movement of the interior door handle is sensed, or if the door moves into an opened position after movement of the interior door handle is sensed;
starting an opening attempt timer to measure a time period when movement of the interior door handle is sensed;
comparing the measured time period to a maximum delay time, with a vehicle lock controller, when the door remains in the unopened position after movement of the interior door handle is sensed, to determine if the measured time period is equal to or greater than the maximum delay time, or if the measured time period is less than the maximum delay time;
sensing a current status of a door lock system with a lock switch to determine if the door lock system is disposed in a locked state or if the door lock system is disposed in an unlocked state, wherein sensing the current status of the door lock system includes sensing a current state of a double door lock feature of the door lock system to determine if the double door lock feature is disposed in an active state or if the door lock system is disposed in an inactive state; and
automatically generating a control signal to deactivate the double door lock feature if the double door lock feature is disposed in the active state, the measured time period is equal to or greater than the maximum delay time, and the door is in the unopened position.

2. The method of claim 1 further comprising providing instructions with an audio or video device related to a proper procedure for unlocking and opening the door, when movement of the interior door handle is sensed and the door remains in the unopened position after movement of the interior door handle.

3. The method of claim 2, wherein providing instructions with the audio or video device is further defined as providing instructions with the audio or video device when the measured time period is equal to or greater than the maximum delay time.

4. The method of claim 2 further comprising resetting a value of an instruction counter equal to zero when the instructions are provided and incrementing a value of the instruction counter by one for each time instructions are provided.

5. The method of claim 4 further comprising comparing the value of the instruction counter to a first counter value, with a vehicle lock controller, to determine if the value of the instruction counter is equal to or greater than the first counter value, or if the value of the instruction counter is less than the first counter value.

6. The method of claim 5 further comprising automatically contacting a service provider, with an onboard communication device of the vehicle, to request assistance in opening or unlocking the door of the vehicle, when the value of the instruction counter is equal to or greater than the first counter value.

7. The method of claim 6 further comprising starting a double door lock timer to measure a second time period after contacting the service provider.

8. The method of claim 7 further comprising comparing the measured second time period to a maximum lock delay time, with the vehicle lock controller, when the double door lock feature remains in the inactive state, to determine if the measured second time period is equal to or greater than the maximum lock delay time or if the measure second time period is less than the maximum lock delay time.

9. The method of claim 8 further comprising generating a control signal to activate the double door lock feature if the double door lock feature is disposed in the inactive state, the measured second time period is equal to or greater than the maximum lock delay time, and the door is in the closed position.

10. A method of controlling a door lock system of a vehicle, the method comprising:
sensing a current status of the door lock system with a lock switch to determine if the door lock system is disposed in a locked state or if the door lock system is disposed in an unlocked state, wherein sensing the current status of the door lock system includes sensing a current state of a double door lock feature of the door lock system to determine if the double door lock feature is disposed in an active state or if the door lock system is disposed in an inactive state;
sensing movement of an interior door handle of the door with a sensing device;
starting an opening timer to measure a time period after movement of the interior door handle is sensed;
sensing a position of the door of the vehicle with a door position sensor after movement of the interior door handle is sensed, to determine if the door remains in an unopened position after movement of the interior door handle is sensed, or if the door moves into an opened position after movement of the interior door handle is sensed;
comparing the measured time period to a maximum delay time, with a vehicle lock controller, when the door remains in the unopened position after movement of the interior door handle is sensed, to determine if the measured time period is equal to or greater than the maximum delay time, or if the measured time period is less than the maximum delay time;
automatically generating a control signal to deactivate the double door lock feature if the double door lock feature is disposed in the active state, the measured time period is equal to or greater than the maximum delay time, and the door is in the unopened position; and
automatically contacting a service provider, with an onboard communication device of the vehicle, to request assistance in opening or unlocking the door of the vehicle, when the double door lock feature is in the inactive state, the measured time period is equal to or greater than the maximum delay time, and the door is in the unopened position.

11. The method of claim 10 further comprising providing instructions with an audio or video device related to a proper procedure for unlocking and opening the door, when movement of the interior door handle is sensed, the door remains in the unopened position after movement of the interior door handle, and the measured time period is equal to or greater than the maximum delay time.

12. The method of claim 11 further comprising incrementing a value of an instruction counter by one for each time instructions are provided.

13. The method of claim 12 further comprising automatically contacting the service provider, with an onboard communication device of the vehicle, to request assistance in opening or unlocking the door of the vehicle, when the value of the instruction counter is equal to or greater than a first counter value.

14. The method of claim 13 further comprising moving the door lock system from the locked state to the unlocked state, with the vehicle lock controller, in response to a signal remotely sent from the service provider.

15. A method of controlling a vehicle, the method comprising:
sensing movement of an interior door handle of the vehicle with a sensing device;
sensing a position of a door of the vehicle with a door position sensor after movement of the interior door handle is sensed, to determine if the door remains in an unopened position after movement of the interior door handle is sensed, or if the door moves into an opened position after movement of the interior door handle is sensed;
sensing a current status of a door lock system with a lock switch to determine if the door lock system is disposed in a locked state or if the door lock system is disposed in an unlocked state, wherein sensing the current status of the door lock system includes sensing a current state of a double door lock feature of the door lock system to determine if the double door lock feature is disposed in an active state or if the door lock system is disposed in an inactive state; and
automatically generating a control signal to deactivate the double door lock feature if the double door lock feature is disposed in the active state and the door is in the unopened position.

16. The method of claim 15 further comprising starting an opening attempt timer to measure a time period when movement of the interior door handle is sensed;
comparing the measured time period to a maximum delay time, with a vehicle lock controller, when the door remains in the unopened position after movement of the interior door handle is sensed, to determine if the measured time period is equal to or greater than the maximum delay time, or if the measured time period is less than the maximum delay time; and
automatically generating a control signal to deactivate the double door lock feature if the double door lock feature is disposed in the active state, the measured time period is equal to or greater than the maximum delay time, and the door is in the unopened position.

17. The method of claim 16 further comprising providing instructions with an audio or video device related to a proper procedure for unlocking and opening the door, when movement of the interior door handle is sensed and the door remains in the unopened position after movement of the interior door handle, wherein providing instructions with the audio or video device is further defined as providing instructions with the audio or video device when the measured time period is equal to or greater than the maximum delay time.

18. The method of claim 17 further comprising resetting a value of an instruction counter equal to zero when the instructions are provided and incrementing a value of the instruction counter by one for each time instructions are provided.

19. The method of claim 18 further comprising comparing the value of the instruction counter to a first counter value, with a vehicle lock controller, to determine if the value of the instruction counter is equal to or greater than the first counter value, or if the value of the instruction counter is less than the first counter value.

20. The method of claim 19 further comprising automatically contacting a service provider, with an onboard communication device of the vehicle, to request assistance in opening or unlocking the door of the vehicle, when the value of the instruction counter is equal to or greater than the first counter value.
